(19) United States
(12) Patent Application Publication
(10) Pub. No.: US 2016/0266236 A1
(43) Pub. Date: Sep. 15, 2016

(54) DISTURBANCE SIGNAL DETECTION APPARATUS AND METHOD

(71) Applicant: KOREA AEROSPACE RESEARCH INSTITUTE, Yuseong-gu Daejeon (KR)

(72) Inventors: Jae Min Kang, Daejeon (KR); Deok Won Lim, Daejeon (KR); Moon Beom Heo, Daejeon (KR)

(21) Appl. No.: 14/763,465

(22) PCT Filed: Nov. 20, 2014
(86) PCT No.: PCT/KR2014/011222

§ 371 Date: Jul. 24, 2015

(30) Foreign Application Priority Data
Dec. 5, 2013 (KR) 10-2013-0150649

(51) Int. Cl. G01S 7/02; G01S 5/04; G01S 19/21

(52) U.S. Cl. CPC G01S 7/021; G01S 19/21; G01S 5/04

(57) ABSTRACT

A disturbance signal detection apparatus may comprise; a receiver configured to receive a first signal including at least one distortion signal, a continuous wave (CW) signal detector configured to detect a CW distortion signal from the first signal based on a frequency characteristic, and a filter configured to output a second signal by filtering out the detected CW distortion signal from the first signal.

### TECHNICAL FIELD

Embodiments of the present invention relate to an apparatus and method for detecting a distortion signal, and more particularly, to an apparatus and method for detecting and filtering out a distortion signal to perform position estimation in a case in which multiple jammers transmit various types of signals.

### BACKGROUND ART

A global positioning system (GPS) signal is vulnerable to a distortion signal since the power of the GPS signal received in Earth surface is very low. The distortion signal decreases signal acquisition and tracking performance of a system requiring precise navigation.

In particular, when a distortion signal influences a high-tech landing guidance used for take-off and landing of an aircraft, an accuracy may decrease which may lead to a serious accident.

To prevent such damage, a variety of research on distortion signal detection and jammer position estimation is being conducted. However, a majority of such research is focused on a single jammer that transmits a single type of signal.

When multiple jammers transmit different types of distortion signals, it may be difficult to identify the distortion signals and obtain accurate measurements.

Accordingly, there is a need for an apparatus for detecting types of signals and filtering out a distortion signal when multiple jammers transmit various types of signals.

### DISCLOSURE OF INVENTION

### Technical Solutions

According to an aspect of the present invention, there is provided an apparatus for detecting a distortion signal, the apparatus including a receiver configured to receive a first signal including at least one distortion signal; a continuous wave (CW) signal detector configured to detect a CW distortion signal from the first signal based on a frequency characteristic; and a filter configured to output a second signal by filtering out the detected CW distortion signal from the first signal.

The CW signal detector may be configured to convert the first signal into a frequency domain, and detect a portion satisfying a first discriminant in the frequency domain as the CW distortion signal.

The first discriminant may be configured to discriminate a portion greater than half of a maximum absolute value of the first signal in the frequency domain as the CW distortion signal.

The CW signal detector may be configured to additionally detect at least one of an azimuth and an elevation angle of the detected CW distortion signal.

The apparatus may further include a direct sequence spread spectrum (DSSS) detector configured to detect a DSSS distortion signal from the second signal using a second discriminant based on a characteristic difference of a cross-correlation function.

The DSSS detector may be configured to apply a cross-correlation function to the second signal, and obtain a maximum value among obtained cross-correlation values.

In detail, the DSSS detector may be configured to apply a delay corresponding to the maximum value to the second discriminant and detect a portion satisfying the second discriminant as the DSSS distortion signal, and the second discriminant may be expressed by

$${R}_{{s}_{fil}} ( {τ}_{TD} + 1 ) > \frac{1}{2} {R}_{{s}_{fil}} ( {τ}_{TD} ) ,$$

wherein R_{S fit} denotes a cross-correlation function, and τ_{TD} denotes a delay corresponding to a maximum value of a cross-correlation value.

The DSSS detector may be configured to additionally detect a time difference of arrival (TDOA) of the detected DSSS distortion signal.

The apparatus may further include a swept continuous wave (SCW) detector configured to detect an SCW distortion signal by verifying a presence of a time-varying frequency component through a time-frequency spectrum analysis.

The apparatus may further include an SCW detector configured to apply a cross-correlation function to the second signal, and detect a portion having a cross-correlation value greater than a preset threshold as an SCW distortion signal.

The SCW detector may be configured to additionally detect a TDOA of the detected SCW distortion signal.

According to another aspect of the present invention, there is also provided a method of detecting a distortion signal, the method including receiving, by a receiver, a first signal including at least one distortion signal; detecting, by a CW signal detector, a CW distortion signal from the first signal based on a frequency characteristic; and outputting, by a filter, a second signal by filtering out the detected CW distortion signal from the first signal.

The detecting may include converting, by the CW signal detector, the first signal into a frequency domain, and detecting a portion satisfying a first discriminant in the frequency domain as the CW distortion signal.

The first discriminant may be configured to discriminate a portion greater than half of a maximum absolute value of the first signal in the frequency domain as the CW distortion signal.

The method may further include detecting, by a DSSS detector, a DSSS distortion signal from the second signal using a second discriminant based on a characteristic difference of a cross-correlation function.

The detecting of the DSSS distortion signal may include applying, by the DSSS detector, a cross-correlation function to the second signal, and obtaining a maximum value among obtained cross-correlation values.

The DSSS detector may be configured to apply a delay corresponding to the maximum value to the second discriminant and detect a portion satisfying the second discriminant as the DSSS distortion signal, and the second discriminant may be expressed by

$${R}_{{s}_{fil}} ( {τ}_{TD} + 1 ) > \frac{1}{2} {R}_{{s}_{fil}} ( {τ}_{TD} ) ,$$

wherein R_{S fit} denotes a cross-correlation function, and τ_{TD} denotes a delay corresponding to a maximum value of a cross-correlation value.

The method may further include detecting, by an SCW detector, an SCW distortion signal by verifying a presence of a time-varying frequency component through a time-frequency spectrum analysis.

The method may further include applying, by an SCW detector, a cross-correlation function to the second signal, and detecting a portion having a cross-correlation value greater than a preset threshold as an SCW distortion signal.

According to still another aspect of the present invention, there is also provided a non-transitory computer-readable medium including a program for instructing a computer to perform the method.

### BRIEF DESCRIPTION OF DRAWINGS

FIG. 1 is a block diagram illustrating a configuration of an apparatus for detecting a distortion signal according to an embodiment.

FIG. 2 is a flowchart illustrating a method of detecting a distortion signal according to an embodiment.

FIG. 3 is a diagram illustrating cross-correlation values of multiple types of distortion signals according to an embodiment.

FIG. 4 is a diagram illustrating cross-correlation values obtained by removing a continuous wave (CW) distortion signal according to an embodiment.

FIG. 5 is a diagram illustrating cross-correlation values of a direct sequence spread spectrum (DSSS) distortion signal and a swept continuous wave (SCW) distortion signal according to an embodiment.

FIG. 6 is a diagram illustrating cross-correlation values of an SCW distortion signal according to an embodiment.

FIG. 7 illustrates a spectrum of an SCW distortion signal according to an embodiment.

FIG. 8 is a diagram illustrating cross-correlation values of a spectrum with respect to a single predetermined frequency according to an embodiment.

### BEST MODE FOR CARRYING OUT THE INVENTION

Hereinafter, reference will now be made in detail to examples with reference to the accompanying drawings, wherein like reference numerals refer to like elements throughout.

The terms used herein are mainly selected from general terms currently being used in light of functions in the present disclosure. Yet, other terms may be used based on the development and/or changes in technology, a custom, or a preference of an operator.

In addition, in a specific case, most appropriate terms are arbitrarily selected by the applicant for ease of description and/or for ease of understanding. In this instance, the meanings of the arbitrarily used terms will be clearly explained in the corresponding description. Hence, the terms should be understood not by the simple names of the terms but by the meanings of the terms and the following overall description of this specification.

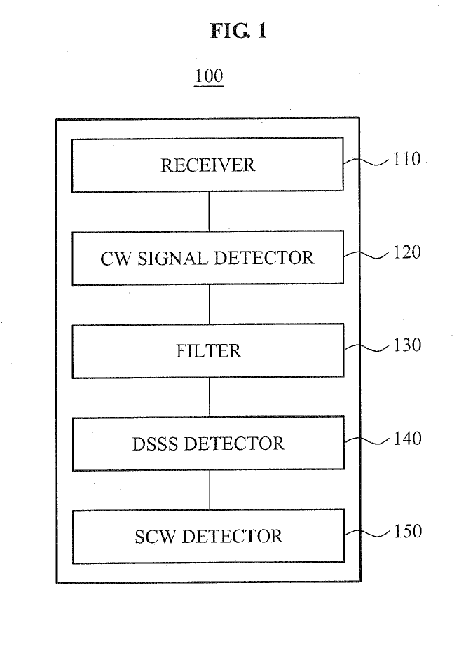

FIG. 1 is a block diagram illustrating a configuration of an apparatus for detecting a distortion signal according to an embodiment.

An apparatus 100 for detecting a distortion signal may include a receiver 110, a continuous wave (CW) signal detector 120, a filter 130, a direct sequence spread spectrum (DSSS) detector 140, and a swept continuous wave (SCW) detector 150.

The receiver 110 may receive a first signal including at least one distortion signal.

The CW signal detector 120 may detect a CW distortion signal from the first signal based on a frequency characteristic.

The CW distortion signal may be a signal having a constant vibration amplitude and including only an unmodulated carrier wave. The CW distortion signal may be expressed by Equation 1.

S_{cw}(t)=A cos(ω_{c}t) [Equation 1]

A denotes an intensity of a signal, W_{C} is 2πf_{c}, and f_{c} denotes a frequency of a carrier wave.

A measurement of the CW distortion signal may be obtained using a direction finding (DF) technique, and a position of a jammer may be estimated using an angle of arrival (AOA) technique.

The DF technique may include Barlett, Capon Minimum Variance, Multiple Signal Identification and Classification (MUSIC), Estimation of Signal Parameter via Rotational Invariance Technique (ESPRIT), and Maximum Likelihood (ML).

Herein, MUSIC will be described as an example used to detect and filter out a CW distortion signal.

When M distortion signals are incident to an array antenna including L antenna devices, an input signal \tilde{x}(t) may be expressed by Equation 2.

$$\tilde{x} ( k ) = {\sum }_{i = 1}^{M} α ( {θ}_{i} , {φ}_{i} ) {\tilde{s}}_{i} ( t ) + {\tilde{n}}_{i} ( t ) \\ {\begin{matrix}\tilde{x} ( k ) = [ \begin{matrix}α ( {θ}_{1} , {φ}_{1} ) \\ ⋮ \\ α ( {θ}_{M} , {φ}_{M} )\end{matrix} ] \\ = \tilde{A} ( t ) \tilde{s} ( t ) + \tilde{n} ( t )\end{matrix}}^{T} [ \begin{matrix}{\tilde{s}}_{1} ( t ) \\ ⋮ \\ {\tilde{s}}_{M} ( t )\end{matrix} ] + [ \begin{matrix}{\tilde{n}}_{1} ( t ) \\ ⋮ \\ {\tilde{n}}_{M} ( t )\end{matrix} ] \qquad [ Equation 2 ]$$

Here, \tilde{S}ᵢ(t) denotes a vector of a signal transmitted from an i-th signal source, α(θᵢ, φᵢ) denotes a direction vector of an i-th signal, and ñᵢ(t) denotes a noise vector having a normal distribution. A covariance matrix of the input signal may be expressed by Equation 3.

$$\begin{matrix}\tilde{R} ( t ) = E [ \tilde{x} ( t ) {\tilde{x} ( t )}^{H} ] \\ = \tilde{A} E [ \tilde{s} ( t ) {\tilde{s} ( t )}^{H} ] {\tilde{A}}^{H} + E [ \tilde{n} ( t ) {\tilde{n} ( t )}^{H} ] \\ = \tilde{A} S {\tilde{A}}^{H} + {σ}^{2} I\end{matrix} \qquad [ Equation 3 ]$$

Here, when a rank M of a matrix ÃSÃ^{H} is less than the number L of the devices included in the array antenna, a minimum eigenvalue of the matrix ÃSÃ^{H} may be “0”, and the matrix ÃSÃ^{H} may have L-M multiplicities. The matrix ÃSÃ^{H} may be represented by an eigen-decomposed matrix, as expressed by Equation 4.

$$\tilde{A} S {\tilde{A}}^{H} = V [ \begin{matrix}{Λ}_{M} & 0 \\ 0 & 0\end{matrix} ] {V}^{H} \qquad [ Equation 4 ]$$

Here, V=[v₁ v₂ . . . v_{L}] denotes an orthogonal eigenvector, and Λ_{M} denotes M nonzero eigenvalues. Equation 3 may be arranged by a discrete time and rearranged using Equation 4, as expressed by Equation 5.

$$\tilde{R} ( k ) = V [ \begin{matrix}{Λ}_{M} & 0 \\ 0 & 0\end{matrix} ] {V}^{H} + {σ}^{2} {VV}^{H} = V Λ {V}^{H} \\ Here , Λ = [ \begin{matrix}{Λ}_{M} + {σ}^{2} I & 0 \\ 0 & {σ}^{2} I\end{matrix} ] is satisfied . \qquad [ Equation 5 ]$$

From Equation 4, it may be learned that a subspace is divided into a distortion signal and noise. Equation 6 expresses an eigenvalue indicating a subspace of a signal, and Equation 7 expresses an eigenvalue indicating a subspace of noise. Thus, a number of distortion signals may be predicted based on a value obtained by subtracting a number of eigenvalues satisfying Equation 7 from the number L of eigenvalues.

λᵢ>σ², i=1, . . . ,M [Equation 6]

λᵢ=σ2, i=M+1, . . . ,L [Equation 7]

As described above, MUSIC may use an orthogonality (Vₙ^{H}Ã≅0) of a direction vector Ã of a signal and an eigenvector Vₙ=[v_{M+1} v_{M+2} . . . v_{L}] corresponding to noise, among eigenvectors of a signal input into an array antenna. Thus, in MUSIC, output power P_{MUSIC} (θ,φ) may be expressed by Equation 8.

$${P}_{MUSIC} ( θ , φ ) = \frac{1}{{α}^{H} ( θ , φ ) {V}_{n} {V}_{n}^{H} α ( θ , φ )} \qquad [ Equation 8 ]$$

The output power P_{MUSIC} (θ, φ) of Equation 8, which is an objective) function for (θᵢ, φᵢ), may be determined, and an angle at which a power spectrum of each distortion signal is maximized may be determined to be an AOA of each of the M distortion signals.

The filter 130 may filter out the detected CW distortion signal from the first signal including the distortion signal.

The CW signal detector 120 may convert the first signal into a frequency domain. A portion satisfying a first discriminant in the converted frequency domain may be detected as the CW distortion signal.

The first discriminant may be used to discriminate a portion greater than half of a maximum absolute value of the first signal in the frequency domain as the CW distortion signal. Further, the CW signal detector 120 may additionally detect at least one of an azimuth and an elevation angle of the detected CW distortion signal.

The DSSS detector 140 may detect a DSSS distortion signal from a second signal output by filtering out the CW distortion signal, using a second discriminant based on a characteristic difference of a cross-correlation function.

In detail, the DSSS detector 140 may apply a cross-correlation function to the second signal, and obtain a maximum value among obtained cross-correlation values. Further, the DSSS detector 140 may additionally detect a time difference of arrival (TDOA) of the detected DSSS distortion signal.

The DSSS distortion signal refers to a signal modulated by cos(ω_{c}t) after spreading spectrum is performed on a data signal D(t) based on a pseudo random number (PRN) being a spreading code, and may be expressed by Equation 9.

s_{DSSS}(t)=AD(t)C(t)cos(ω_{c}t) [Equation 9]

Here, C(t) denotes a PRN code, which is, herein, a coarse/acquisition (C/A) code of a global positioning system (GPS) signal and has a transmission rate of 1.023 megachips per second (Mcps).

To obtain a measurement of a DSSS signal, a TDOA technique may be used. The TDOA technique refers to a technique of estimating a position using a TDOA of a signal as a measurement. A position of a jammer calculated from a TDOA between two sensors may be represented in a form of a hyperbola, and the position of the jammer may be estimated by obtaining an intersection point of multiple hyperbolas.

A TDOA between two predetermined sensors may be obtained using a cross-correlation function. The cross-correlation function may be defined as expressed by Equation 10.

$${R}_{ri} ( τ ) {=}^{Δ} E [ {x}_{r} ( t ) {x}_{i} ( t - τ ) ] = \frac{1}{T} {\int }_{0}^{T} {x}_{r} ( t ) {x}_{i} ( t - τ ) d τ \qquad [ Equation 10 ]$$

Here, xᵣ(t) and xᵢ(t) denote signals transmitted by a jammer and to received by a reference sensor and an i-th sensor, respectively, T denotes a period of a signal, and τ denotes a delay time.

When a period of a transmitted signal is longer than a TDOA, a cross-correlation result may have a single maximum value. In this example, a delay time (τᵣᵢ) that maximizes the cross-correlation result may be a TDOA, for example, a TDOA measurement.

The SCW detector 150 may detect an SCW distortion signal by verifying a presence of a time-varying frequency component through a time-frequency spectrum analysis.

Further, the SCW detector 150 may apply a cross-correlation function to the second signal output by filtering out the CW distortion signal, and detect a portion having a cross-correlation value greater than a preset threshold as the SCW distortion signal.

In addition, the SCW detector 150 may detect a TDOA of the detected SCW distortion signal.

The SCW distortion signal may be a sinusoidal signal having a time-varying frequency, and have a characteristic of a narrowband signal. The SCW distortion signal may be expressed by Equation 11.

x(t)=a sin [2π(f₀+kt/2)t], (0≦t<T_{SW}) [Equation 11]

Here, a denotes an amplitude, and has a constant value. f₀ denotes an initial frequency, k denotes a chirp rate, and T_{SW} denotes a sweep time. Equation 11 may be expressed by a discrete time, as given by Equation 12.

x(n)=a sin [2π(f₀+knT_{SP}/2)nT_{SP}] [Equation 12]

n being integer, 0≦n<T_{SW}/T_{SP}

Here, T_{SW} denotes a sampling period, and B denotes a bandwidth. The bandwidth may be defined as expressed by Equation 13.

B [symbol] kT_{sw}/2 [Equation 13]

An SCW signal may be iteratively generated at each sweep time. When an SCW signal is iteratively generated, a cross-sectional value of the SCW signal may be iterated at each sweep time although a cross-correlation is performed on the SCW signal. Thus, in principle, a single TDOA measurement may not be obtained due to an ambiguity.

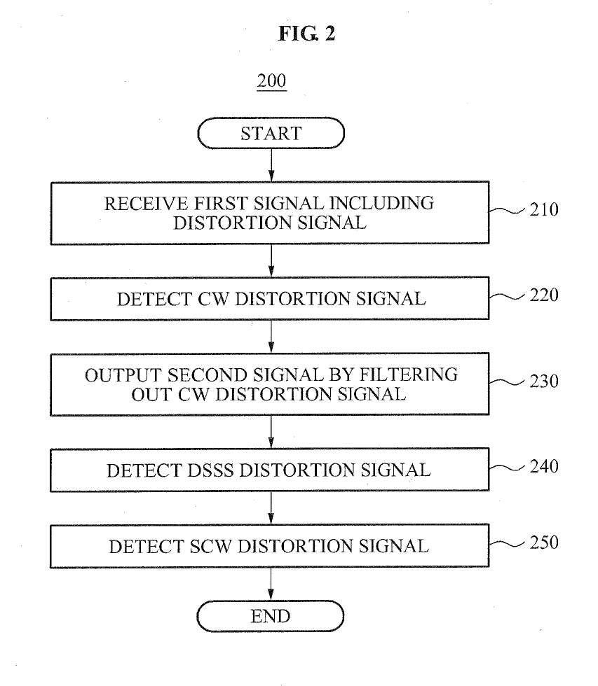

FIG. 2 is a flowchart illustrating a method of detecting a distortion signal according to an embodiment.

In operation 210, the receiver 110 of the apparatus 100 for detecting a distortion signal may receive a first signal including at least one distortion signal.

In operation 220, the CW signal detector 120 may detect a CW distortion signal from the first signal based on a frequency characteristic.

The CW signal detector 120 may convert the first signal from a time domain to a frequency domain through fast Fourier transform (FFT). After the conversion, the CW signal detector 120 may detect the CW distortion signal from a spectrum of the converted signal.

In operation 230, the filter 130 may output a second signal by filtering out the detected CW distortion signal from the first signal.

In the operation of detecting the CW distortion signal, the CW signal detector 120 may convert the first signal into a frequency domain, and detect a portion satisfying a first discriminant in the frequency domain as the CW distortion signal.

In detail, the first discriminant may be used to discriminate a portion greater than half of a maximum absolute value of the first signal in the frequency domain as the CW distortion signal. The first discriminant may be expressed by Equation 14.

$$\vert {X}_{k} ( f ) \vert > \frac{max \vert {X}_{k} ( f ) \vert}{2} \qquad [ Equation 14 ]$$

In operation 240, the DSSS detector 140 may detect a DSSS distortion signal from the second signal using a second discriminant based on a characteristic difference of a cross-correlation function.

The apparatus 100 for detecting a distortion signal may identify a DSSS distortion signal between a DSSS distortion signal and an SCW distortion signal.

A peak value of a cross-correlation value with respect to a DSSS distortion signal may have a shape of a triangle.

The DSSS detector 140 may determine a maximum value among cross-correlation values of a cross-correlation function Rₛ_{_{fil}}(τ), and determine a DSSS distortion signal by applying a delay corresponding to the maximum value to the second discriminant. The second discriminant may be expressed by Equation 15.

$${R}_{{s}_{fil}} ( {τ}_{TD} + 1 ) > \frac{1}{2} {R}_{{s}_{fil}} ( {τ}_{TD} ) \qquad [ Equation 15 ]$$

Here, τ_{TD} D denotes a delay corresponding to a maximum value of a cross-correlation value, and τ_{TD} may be a measurement when satisfying the second discriminant.

By iteratively performing the foregoing process, the DSSS detector 140 may verify whether a DSSS distortion signal is included, and obtain a measurement.

To perform the foregoing process, a distortion signal detected first, among DSSS distortion signals, may be filtered out. A cross-correlation value having a shape of a triangle with respect to a delay prior to or subsequent to τ_{TD} with respect to the detected DSSS distortion signal may be substituted with “0”.

In operation 250, the SCW detector 150 may detect an SCW distortion signal by verifying a presence of a time-varying frequency component through a time-frequency spectrum analysis.

Further, in operation 250, the SCW detector 150 may apply a distortion-correlation function to the second signal, and detect a portion having a cross-correlation value greater than a preset threshold as the SCW distortion signal.

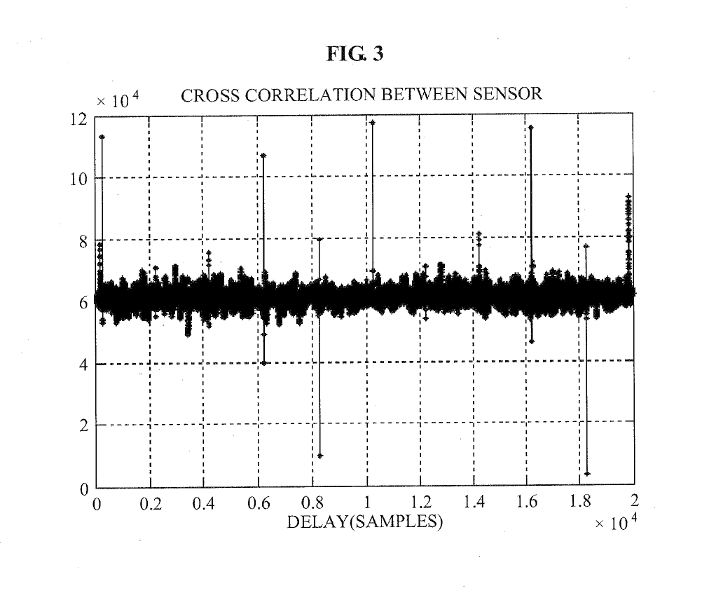

FIG. 3 is a diagram illustrating cross-correlation values of multiple types of distortion signals according to an embodiment.

In an example, four sensors having array antennas of five elements and four jammers may be provided. A single CW distortion signal, two DSSS distortion signals, and a single SCW distortion signals may be transmitted. In this example, the signals may be expressed by Equation 16.

xₛ(t)=x_{CW}(t)+_{DSSS1}(t)+x_{DSSS2}(t)+x_{SCW}(t) [Equation 16]

To identify signals received by the sensors, frequency characteristics may be analyzed using FFT.

Due to effects of the DSSS and SCW signals, a frequency characteristic on a periphery of a peak value may differ only when the CW signal is present.

When multiple distortion signals are incident, a measurement may be obtained using MUSIC. However, when a position is estimated based on the obtained measurement, the accuracy may decrease. A cross-correlation value obtained using a cross-correlation is illustrated in FIG. 3.

Referring to FIG. 3, since the cross-correlation values include characteristics of a DSSS signal, a CW signal, and an SCW signal, a bias may exist in the cross-correlation values, and a number of peaks may be generated in the cross-correlation values. Thus, when a measurement is obtained using a cross-correlation, a cross-correlation characteristic may deteriorate and a TDOA measurement may not be obtained.

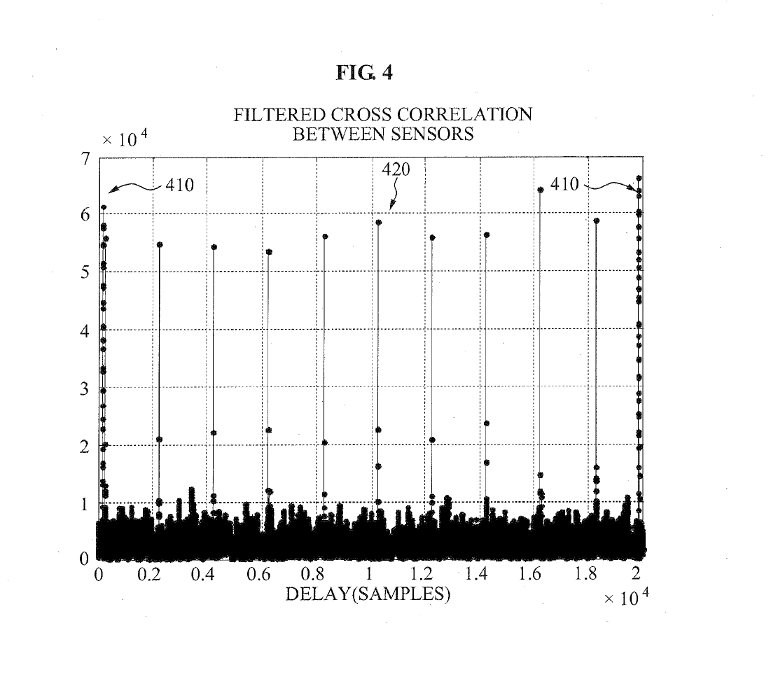

FIG. 4 is a diagram illustrating cross-correlation values obtained by removing a CW distortion signal according to an embodiment.

FIG. 4 illustrates a cross-correlation result obtained by removing a CW distortion signal through filtering. Items 410 denote cross-correlation values of DSSS distortion signals, and an item 420 denotes a cross-correlation value of an SCW distortion signal.

Referring to the cross-correlation result of FIG. 4, a number of peak values greater than a threshold are present. Since the DSSS distortion signals and the SCW distortion signal are included together, a number of peak values greater than the threshold may exist.

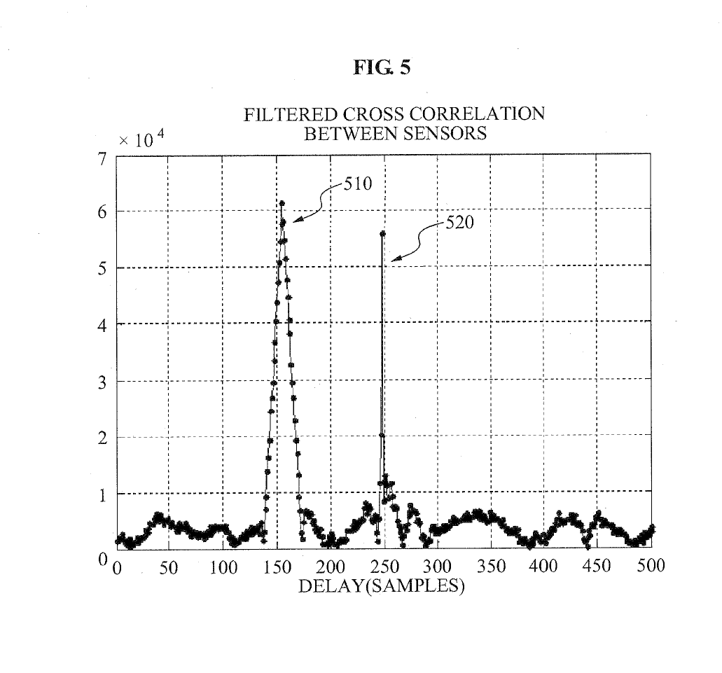

FIG. 5 is a diagram illustrating cross-correlation values of a DSSS distortion signal and an SCW distortion signal according to an embodiment.

A DSSS distortion signal may have a cross-correlation peak in a shape of a triangle, and an SCW distortion signal may have a cross-correlation peak in a shape of an impulse.

An apparatus for detecting a distortion may obtain a measurement by identifying a DSSS distortion signal between a DSSS distortion signal and an SCW distortion signal. A cross-correlation value of the DSSS distortion signal may have a shape of a triangle. Thus, the DSSS distortion signal may be determined by determining a maximum value among cross-correlation values of a cross-correlation function, and applying a delay corresponding to the maximum value to a discriminant.

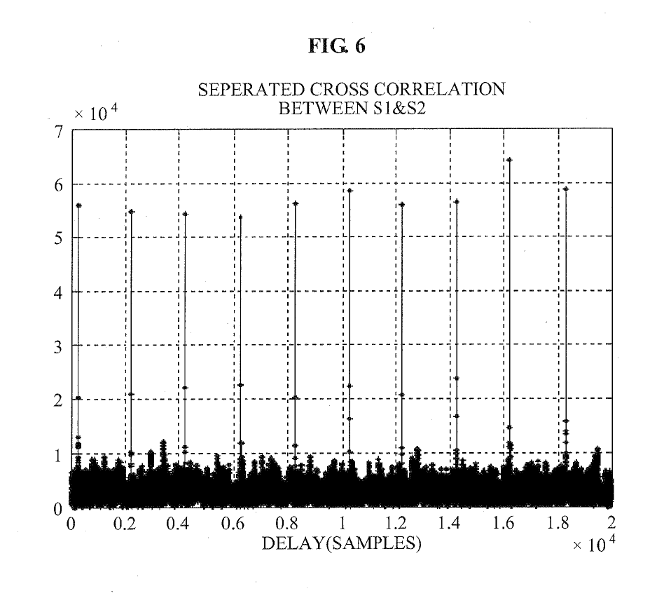

FIG. 6 is a diagram illustrating cross-correlation values of an SCW distortion signal according to an embodiment.

An apparatus for detecting a distortion may identify an SCW distortion signal and obtain a measurement. When it is verified that a DSSS distortion signal is included, a process of removing the DSSS distortion signal may be performed. A cross-correlation result obtained by removing the DSSS distortion signal may include only a SCW signal component, as shown in FIG. 6.

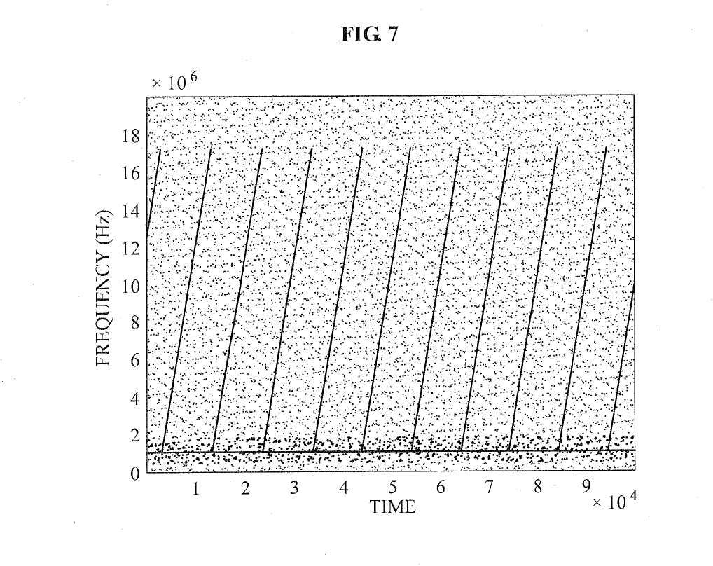

FIG. 7 illustrates a spectrum of an SCW distortion signal according to an embodiment.

An SCW distortion signal is a time-varying frequency signal, as mentioned in Equation 11. Thus, a result as shown in FIG. 7 may be obtained using a spectrum.

In FIG. 7, frequency components distributed on a periphery of a center frequency of IF (Intermediate Frequency) of 1.134 MHz may be of a DSSS signal.

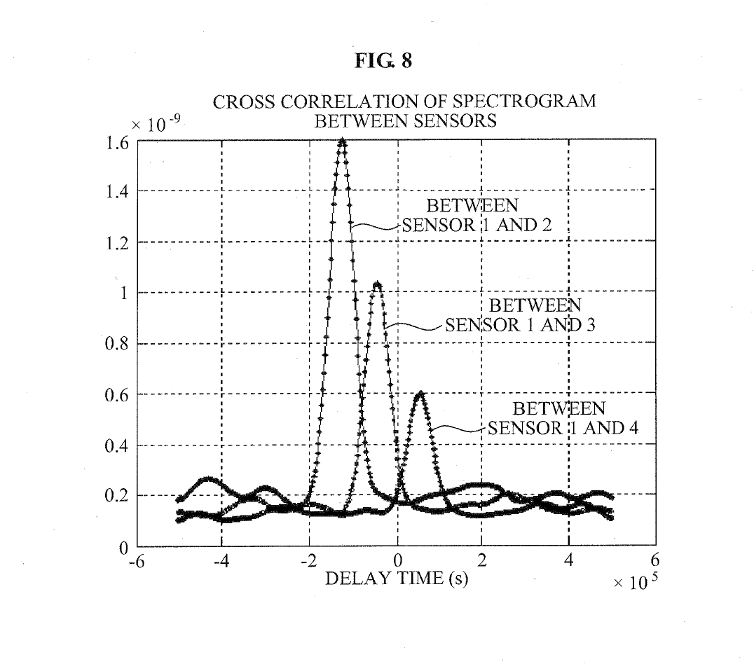

FIG. 8 is a diagram illustrating cross-correlation values of a spectrum with respect to a single predetermined frequency according to an embodiment.

By verifying a presence of a time-varying frequency component, a presence of an SCW signal may be verified. A frequency of a signal received by each sensor at a single predetermined point in time may vary depending on a distance between a jammer and each sensor. When a cross-correlation between different sensors is performed on a spectrum with respect to a single predetermined frequency, a result as shown in FIG. 8 may be obtained.

Here, an approximate measurement with respect to an SCW signal may be obtained from a delay value that maximizes a cross-correlation value. Further, an accurate measurement may be obtained from the result of FIG. 6.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable gate array, a programmable logic unit, a microprocessor or any other device capable of responding to and executing instructions in a defined manner.

The processing device may run an operating system (OS) and one or more software applications that run on the OS. The processing device also may access, store, manipulate, process, and create data in response to execution of the software.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired.

Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts.

Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like.

Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An apparatus for detecting a distortion signal, the apparatus comprising:
a receiver configured to receive a first signal comprising at least one distortion signal;
a continuous wave (CW) signal detector configured to detect a CW distortion signal from the first signal based on a frequency characteristic; and
a filter configured to output a second signal by filtering out the detected CW distortion signal from the first signal.

2. The apparatus of claim 1, wherein the CW signal detector is configured to convert the first signal into a frequency domain, and detect a portion satisfying a first discriminant in the frequency domain as the CW distortion signal.

3. The apparatus of claim 2, wherein the first discriminant is configured to discriminate a portion greater than half of a maximum absolute value of the first signal in the frequency domain as the CW distortion signal.

4. The apparatus of claim 1, wherein the CW signal detector is configured to additionally detect at least one of an azimuth and an elevation angle of the detected CW distortion signal.

5. The apparatus of claim 1, further comprising:
a direct sequence spread spectrum (DSSS) detector configured to detect a DSSS distortion signal from the second signal using a second discriminant based on a characteristic difference of a cross-correlation function.

6. The apparatus of claim 5, wherein the DSSS detector is configured to apply a cross-correlation function to the second signal, and obtain a maximum value among obtained cross-correlation values.

7. The apparatus of claim 6, wherein the DSSS detector is configured to apply a delay corresponding to the maximum value to the second discriminant and detect a portion satisfying the second discriminant as the DSSS distortion signal, and
the second discriminant is expressed by
$${R}_{{s}_{fil}} ( {τ}_{TD} + 1 ) > \frac{1}{2} {R}_{{s}_{fil}} ( {τ}_{TD} ) ,$$
wherein R_{S fit} denotes a cross-correlation function, and τ_{TD} denotes a delay corresponding to a maximum value of a cross-correlation value.

8. The apparatus of claim 5, wherein the DSSS detector is configured to additionally detect a time difference of arrival (TDOA) of the detected DSSS distortion signal.

9. The apparatus of claim 1, further comprising:
a swept continuous wave (SCW) detector configured to detect an SCW distortion signal by verifying a presence of a time-varying frequency component through a time-frequency spectrum analysis.

10. The apparatus of claim 1, further comprising:
a SCW detector configured to apply a cross-correlation function to the second signal, and detect a portion having a cross-correlation value greater than a preset threshold as an SCW distortion signal.

11. The apparatus of claim 1, wherein the SCW detector is configured to additionally detect a TDOA of the detected SCW distortion signal.

12. A method of detecting a distortion signal, the method comprising:
receiving, by a receiver, a first signal comprising at least one distortion signal;
detecting, by a continuous wave (CW) signal detector, a CW distortion signal from the first signal based on a frequency characteristic; and
outputting, by a filter, a second signal by filtering out the detected CW distortion signal from the first signal.

13. The method of claim 12, wherein the detecting comprises converting, by the CW signal detector, the first signal into a frequency domain, and detecting a portion satisfying a first discriminant in the frequency domain as the CW distortion signal.

14. The method of claim 13, wherein the first discriminant is configured to discriminate a portion greater than half of a maximum absolute value of the first signal in the frequency domain as the CW distortion signal.

15. The method of claim 12, further comprising:
detecting, by a direct sequence spread spectrum (DSSS) detector, a DSSS distortion signal from the second signal using a second discriminant based on a characteristic difference of a cross-correlation function.

16. The method of claim 15, wherein the detecting of the DSSS distortion signal comprises applying, by the DSSS detector, a cross-correlation function to the second signal, and obtaining a maximum value among obtained cross-correlation values.

17. The method of claim 16, wherein the DSSS detector is configured to apply a delay corresponding to the maximum value to the second discriminant and detect a portion satisfying the second discriminant as the DSSS distortion signal, and
the second discriminant is expressed by
$${R}_{{s}_{fil}} ( {τ}_{TD} + 1 ) > \frac{1}{2} {R}_{{s}_{fil}} ( {τ}_{TD} ) ,$$
wherein R_{S fit} denotes a cross-correlation function, and τ_{TD} denotes a delay corresponding to a maximum value of a cross-correlation value.

18. The method of claim 12, further comprising:
detecting, by a swept continuous wave (SCW) detector, an SCW distortion signal by checking a presence of a time-varying frequency component through a time-frequency spectrum analysis.

19. The method of claim 12, further comprising:
applying, by a SCW detector, a cross-correlation function to the second signal, and detecting a portion having a cross-correlation value greater than a preset threshold as a SCW distortion signal.

20. A non-transitory computer-readable medium comprising a program for instructing a computer to perform the method of claim 12.
